(19) United States
(12) Patent Application Publication
(10) Pub. No.: US 2013/0215036 A1
(43) Pub. Date: Aug. 22, 2013

(54) KEYBOARD DEVICE

(71) Applicant: Chih-Ming Hsu, Taipei (TW)

(72) Inventor: Chih-Ming Hsu, Taipei (TW)

(73) Assignee: PRIMAX ELECTRONICS LTD., Taipei (TW)

(21) Appl. No.: 13/463,481

(22) Filed: May 3, 2012

(30) Foreign Application Priority Data
Feb. 17, 2012 (TW) 101105277

(51) Int. Cl. G06F 3/023

(52) U.S. Cl. 345/168

(57) ABSTRACT

The present invention discloses a keyboard device including a plurality of first number key, a shift key, a plurality of second number key and a control unit. When the control unit receives a shift key code generated by the shift key and a first number key code generated by the first number key, the control unit outputs a special symbol signal corresponding to the first number key code. When the control unit receives the first number key code or a second number key code generated by the second number key, the control unit outputs a number signal corresponding to the first number key code. When the control unit receives the shift key code and the second number key code, the control unit outputs a cutoff signal, such that a computer system stops executing commands.

### FIELD OF THE INVENTION

The present invention generally relates to a keyboard device, and more particularly to a keyboard device with a plurality of number keys arranged at the right side thereof.

### BACKGROUND OF THE INVENTION

Here in the technology and information age, the computer and peripherals thereof has become a part of the daily life of everybody whether at work or entertainment, and the input devices, such as the mouse device, the keyboard device, the trackball device and so on, used as the communication between the computer and the user has attracted increasing attention.

An object herein is concentrated in a keyboard device among the input devices, and a structure of a conventional keyboard device is illustrated hereinafter. FIG. 1 illustrates an external structural schematic view of a conventional keyboard device. Referring to FIG. 1, the conventional keyboard device 1 is in communication with a computer system (not shown in FIGs), and the conventional keyboard device 1 comprises a first key region 11, a second key region 12, a third key region 13 and a fourth key region 14. Herein, the first key region 11 is defined as a standard key region, the second key region 12 is defined as a number key region, the third key region 13 is defined as a function key region, and the fourth key region 14 is defined as an expansion key region.

The first key region 11 comprises a plurality of letter keys 111, a plurality of first number keys 112 and two shift keys 113. Each one of the plurality of letter keys 111 is capable of being pressed down by the user, so as to key in a corresponding lowercase letter to a computer system in communication with the keyboard device 1. The plurality of first number keys 112 are arranged at an upside of the plurality of letter keys 111, wherein each one of the plurality of first number keys 112 is capable of being pressed down by the user, so as to key in a corresponding number to the computer system. The two shift keys 113 are respectively located at two opposite sides of the plurality of letter keys 111. When one of the shift keys 113 is continuously pressed down and one of the letter keys 111 or one of the first number keys 112 is pressed down at the same time, an uppercase letter corresponding to that letter key 111 or a special symbol corresponding to that first number key 112 is key in to the computer system, wherein the special symbols comprise “!”, “@”, “#”, “$”, “%”, “̂”, “&”, “*”, “(”, “)” and so on. Of course, each one of number key surfaces of the plurality of first number keys 112 is presented with a special symbol character and a number symbol character, for example the number key surface of the first number key “1” is presented with the special symbol character “!” and the number symbol character “1”.

The second key region 12 is arranged at a right side of the first key region 11 and comprises a plurality of the second number keys 121 and a number lock key 122, wherein each one of the plurality of second number keys 121 is capable of being pressed down, so as to key in a corresponding number to the computer system or to let the computer system execute a corresponding function command. When the computer system detects that the conventional keyboard device 1 is in a number lock state due to the number lock key 122 is pressed down and then one of the plurality of second number keys 121 is pressed down, a number corresponding to that second number key 121 is key in to the computer system. In contrast, when the computer system detects that the conventional keyboard device 1 is in a number unlock state due to the number lock key 122 is pressed down and then one of the plurality of second number keys 121 is pressed down, a function command corresponding to that second number key 121 is executed by the computer system. Herein, those function commands comprise a function of shifting to “Home”, a function of shifting to “End”, a function of “Pageup”, a function of “Pagedown”, a function of moving upward, a function of moving downward, a function of moving leftward, a function of moving rightward and so on. Similar to the first number keys 111, each one of number key surfaces of the plurality of second number keys 121 is presented with a special symbol character and a number symbol character, for example the number key surface of the second number key “1” is presented with the special symbol character “End” (corresponding to the function of shifting to “End”) and the number symbol character “1”.

The third key region 13 comprises a plurality of function keys 131 arranged at an upside of the plurality of first number keys 112, and each one of the plurality of function keys 131 is capable of being pressed down by the user, so as to let the computer system execute a corresponding function command, wherein the function commands comprise the function commands of F1 to F12 and so on. In contrast, the fourth key region 14 is arranged between the first key region 11 and the second key region 12 and comprises a plurality of expansion keys 141, and each one of the expansion keys 141 is capable of being pressed down by the user, so as to let the computer system execute a corresponding function command, wherein the function commands comprise the function of Delete, the function of shifting to Home, the function of shifting to End, the function of Pageup, the function of Pagedown, the function of moving upward, the function of moving downward, the function of moving leftward, the function of moving rightward and so on.

The conventional keyboard device 1 further comprises a control unit 10 arranged inside the conventional keyboard device 1, which is electrically connected with the above mentioned keys and capable of recognizing that which key is pressed down by the user. In the conventional keyboard device 1, when at least one of the above mentioned keys is pressed down, the key being pressed down generates a corresponding key code to the control unit 10. After that, the control unit 10 recognizes that which one of the above mentioned keys is pressed down by using a human interface device usage table (HID Usage Table), wherein the HID Usage Table is defaulted in the control unit 10 and lists each one of the above mentioned keys with a key code. The HID Usage Table is shown as the table below:

| | Key |
|---|---|
| Key | code |
| a A | 04 |
| b B | 05 |
| c C | 06 |
| d D | 07 |
| e E | 08 |
| f F | 09 |
| g G | 0A |
| h H | 0B |
| i I | 0C |
| j J | 0D |
| k K | 0E |
| l L | 0F |
| m M | 10 |
| n N | 11 |
| o O | 12 |
| p P | 13 |
| q Q | 14 |
| r R | 15 |
| s S | 16 |
| t T | 17 |
| u U | 18 |
| v V | 19 |
| w W | 1A |
| x X | 1B |
| y Y | 1C |
| z Z | 1D |
| 1 ! | 1E |
| 2 @ | 1F |
| 3 # | 20 |
| 4 $ | 21 |
| 5 % | 22 |
| 6 \hat{ } | 23 |
| 7 & | 24 |
| 8 * | 25 |
| 9 ( | 26 |
| 0 ) | 27 |
| Return | 28 |
| Escape | 29 |
| Backspace | 2A |
| Tab | 2B |
| Space | 2C |
| - _{—} | 2D |
| = + | 2E |
| [ { | 2F |
| ] } | 30 |
| \ \| | 31 |
| Europe 1 | 32 |
| ; : | 33 |
| ‘ “ | 34 |
| ` ~ | 35 |
| , < | 36 |
| . > | 37 |
| / ? | 38 |
| Caps Lock | 39 |
| F1 | 3A |
| F2 | 3B |
| F3 | 3C |
| F4 | 3D |
| F5 | 3E |
| F6 | 3F |
| F7 | 40 |
| F8 | 41 |
| F9 | 42 |
| F10 | 43 |
| F11 | 44 |
| F12 | 45 |
| Print Screen | 46 |
| Scroll Lock | 47 |
| Break | 48 |
| (Ctrl-Pause) | |
| Pause | 48 |
| Insert | 49 |
| Home | 4A |
| Page Up | 4B |
| Delete | 4C |
| End | 4D |
| Page Down | 4E |
| Right Arrow | 4F |
| Left Arrow | 50 |
| Down Arrow | 51 |
| Up Arrow | 52 |
| Num Lock | 53 |
| Keypad / | 54 |
| Keypad * | 55 |
| Keypad − | 56 |
| Keypad + | 57 |
| Keypad Enter | 58 |
| Keypad 1 End | 59 |
| Keypad 2 | 5A |
| Down | |
| Keypad 3 | 5B |
| PageDn | |
| Keypad 4 | 5C |
| Left | |
| Keypad 5 | 5D |
| Keypad 6 | 5E |
| Right | |
| Keypad 7 | 5F |
| Home | |
| Keypad 8 | 60 |
| Up | |
| Keypad 9 | 61 |
| PageUp | |
| Keypad 0 | 62 |
| Insert | |
| Keypad . | 63 |
| Delete | |
| Europe 2 | 64 |
| (Note 2) | |
| App | 65 |
| Keyboard | 66 |
| Power | |
| Keypad = | 67 |
| F13 | 68 |
| F14 | 69 |
| F15 | 6A |
| F16 | 6B |
| F17 | 6C |
| F18 | 6D |
| F19 | 6E |
| F20 | 6F |
| F21 | 70 |
| F22 | 71 |
| F23 | 72 |
| F24 | 73 |
| Execute | 74 |
| Help | 75 |
| Menu | 76 |
| Select | 77 |
| Stop | 78 |
| Again | 79 |
| Undo | 7A |
| Cut | 7B |
| Copy | 7C |
| Paste | 7D |
| Find | 7E |
| Mute | 7F |
| Volume Up | 80 |
| Volume Dn | 81 |
| Locking | 82 |
| Caps Lock | |
| Locking | 83 |
| Num Lock | |
| Locking | 84 |
| Scroll Lock | |
| (Brazilian | 85 |
| Keypad .) | |
| Equal Sign | 86 |
| Int'l 1 | 87 |
| Intl'2 | 88 |
| Int'l 3 | 89 |
| Int'l 4 | 8A |
| Int'l 5 | 8B |
| Int'l 6 | 8C |
| Int'l 7 | 8D |
| Int'l 8 | 8E |
| Int'l 9 | 8F |
| Lang 1 | 90 |
| Lang 2 | 91 |
| Lang 3 | 92 |
| Lang 4 | 93 |
| Lang 5 | 94 |
| Lang 6 | 95 |
| Lang 7 | 96 |
| Lang 8 | 97 |
| Lang 9 | 98 |
| Alternate | 99 |
| Erase | |
| SysReq/ | 9A |
| Attention | |
| Cancel | 9B |
| Clear | 9C |
| Prior | 9D |
| Return | 9E |
| Separator | 9F |
| Out | A0 |
| Oper | A1 |
| Clear/Again | A2 |
| CrSel/Props | A3 |
| ExSel | A4 |
| Left Control | E0 |
| Left Shift | E1 |
| Left Alt | E2 |
| Left GUI | E3 |
| Right | E4 |
| Control | |
| Right Shift | E5 |
| Right Alt | E6 |
| Right GUI | E7 |

For example, when the user presses down the first number key “1” of the first number keys 111 in the first key region 11, the first number key “1” generates the number code “1E”, and then the number code “1E” is transmitted to the control unit 10 via an internal circuit. After that, the control unit 10 generates and thus transmits a key signal corresponding to the key code “1E” to the computer system according to the key code “1E”, so as to key in the number “1” to the computer system. The instance of any one of the other keys being pressed down is all the same as the above mentioned instance of the first number key 111 being pressed down and thus is omitted herein.

According to the above mentioned HID Usage Table, it is understood that the first number keys 111 in the first key region 11 include the numbers “1” to “0”, and the second number keys 121 in the second key region 12 also include the numbers “1” to “0”, wherein the numbers “1” to “0” of the second number keys 121 correspond to the key codes “59” to “62”, and the numbers “1” to “0” of the first number keys 111 correspond to the key codes “1E” to “27”.

There are two approaches for the user to use the conventional keyboard device 1 to key in the desired numbers. The first approach is to switch a keyboard input mode in the computer system into the alphanumeric input mode first, and then press down the plurality of first number keys 111 in the first key region 11. The second approach is to press down the number lock key 122 to switch the conventional keyboard device 1 into the number unlock state, and then press down the plurality of second number keys 121 in the second key region 12. If the user uses the above mentioned first approach to key in the numbers, the user must switch the keyboard input mode into the alphanumeric input mode first, and then the number “1” is able to be keyed in to the computer system by pressing the first number key “1” of the first number keys 111. In another word, when the keyboard input mode is switched into an input mode other than the alphanumeric input mode, the special symbol “!” but not the number “1” is keyed in to the computer system by pressing the first number key “1” of the first number keys 111. In contrast, if the user uses the above mentioned second approach to key in the numbers, the user must use the number lock key 122 to switch the conventional keyboard device 1 into the number lock state first, and then the number “1” is able to be keyed in to the computer system by pressing the second number key “1” of the second number keys 121. In another word, when the conventional keyboard device 1 is switched into the number unlock state, the computer system executes the function of shifting to “End” but not being keyed in the number “1” by pressing the second number key “1” of the second number keys 121. However, for the user, no matter which one of the above mentioned approaches is used, it is not so convenient to key in the numbers. As a result, it is desired to provide a keyboard device capable of conveniently keying in the numbers.

### SUMMARY OF THE INVENTION

The present invention is directed to providing a keyboard device convenient to key in numbers.

The present invention is further directed to providing a keyboard device, wherein it is unnecessary to control the functions of the number keys by using a number lock key.

In a preferred embodiment, the present invention provides a keyboard device, wherein the keyboard device is in communication with a computer system and comprises:
a first key region, comprising:
   a plurality of first number keys, arranged within the first key region and exposed by a surface of the keyboard device, wherein each one of the plurality of first number keys is capable of being pressed down and thus generates a first number key code correspondingly; and
   a shift key, arranged within the first key region and exposed by the surface of the keyboard device;
a second key region, located at a first side of the first key region, the second key region comprising a plurality of second number keys arranged within the second key region and exposed by the surface of the keyboard device, wherein each one of the plurality of second number keys is capable of being pressed down and thus correspondingly generates a second number key code; and
a control unit, arranged within the keyboard device and electrically connected with the plurality of first number keys, the plurality of second number keys and the shift key, wherein when the control unit receives a shift key code generated by the shift key and the first number key code generated by a corresponding one of the plurality of first number keys, the control unit outputs a special symbol signal corresponding to the first number key code; when the control unit receives the first number key code or the second number key code, the control unit outputs a number signal corresponding to the first number key code; and when the control unit receives the shift key code and the second number key code, the control unit outputs a cutoff signal.

In a preferred embodiment, the computer system comprises:
a computer host, in communication with the control unit, capable of running at least one application program, and the at least one application program receiving the number signal or the special symbol signal and thus correspondingly executing a command; and
a computer screen, in communication with the computer host, capable of displaying the at least one application program and displaying a number corresponding to the number signal and a special symbol corresponding to the special symbol signal.

In a preferred embodiment, when the computer host runs the at least one application program and receives the number signal, the computer host inputs the number corresponding to the number signal into the at least one application program, and the at least one application program and the number are displayed on the computer screen; when the computer host runs the at least one application program and receives the special symbol signal, the computer host inputs the special symbol corresponding to the special symbol signal into the at least one application program, and the at least one application program and the special symbol are displayed on the computer screen; and when the computer host runs the at least one application program and receives the cutoff signal, the computer host stops executing the command.

In a preferred embodiment, the second key region further comprises a clear key arranged within the second key region, exposed by the surface of the keyboard device, and capable of being pressed down and thus generating a clear key code, such that the control unit outputs a clear signal to the computer host according to the clear key code.

In a preferred embodiment, when the computer host runs the at least one application program and receives the clear signal, the computer host changes the number inputted into the at least one application program into 0.

In a preferred embodiment, the at least one application program is a calculator program capable of running in a Windows operating system (OS) or a calculator program capable of running in a Mac operating system.

In a preferred embodiment, when the computer host runs the at least one application program and receives the clear signal, the computer host executes a Delete command.

In a preferred embodiment, the at least one application program is a Microsoft Word program capable of running in a Windows operating system, a Microsoft Excel program capable of running in the Windows operating system, a Microsoft Powerpoint program capable of running in the Windows operating system, a Microsoft Word program capable of running in a Mac operating system, a Microsoft Excel program capable of running in the Mac operating system, a Microsoft Powerpoint program capable of running in the Mac operating system, a Page program in the Mac operating system, a Numbers program in the Mac operating system or a Keynote program in the Mac operating system.

In a preferred embodiment, the plurality of first number key codes generated by the plurality of first number keys are 1E, 1F, 20, 21, 22, 23, 24, 25, 26 and 27, and the plurality of second number key codes generated by the plurality of second number keys are 59, 5A, 5B, 5C, 5D, 5E, 5F, 60, 61 and 62.

In a preferred embodiment, each one of number key surfaces of the plurality of first number keys is presented with a special symbol character and a number symbol character, but each one of number key surfaces of the plurality of second number keys is presented with the number symbol character only.

### BRIEF DESCRIPTION OF THE DRAWINGS

FIG. 1 illustrates an external structural schematic view of a conventional keyboard device.

FIG. 2 illustrates an external structural schematic view of a keyboard device according to a preferred embodiment of the present invention.

FIG. 3 illustrates an external structural schematic view of a keyboard device in communication with a computer system according to a preferred embodiment of the present invention.

FIG. 4 illustrates an operation block diagram of a control unit of a keyboard device according to a preferred embodiment of the present invention.

FIG. 5A to FIG. 5C illustrate a serial external structural schematic views about operating a keyboard device for controlling a computer system to run an application program according to a preferred embodiment of the present invention.

FIG. 6A and FIG. 6B illustrate a serial external structural schematic views about operating a keyboard device for controlling a computer system to run another application program according to a preferred embodiment of the present invention.

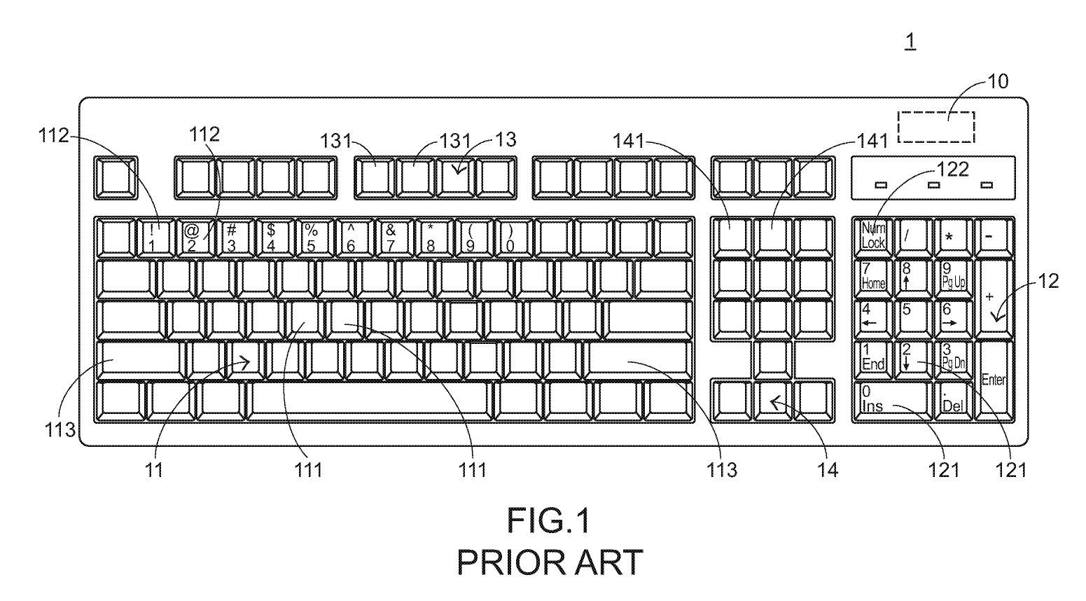

### DETAILED DESCRIPTION OF THE PREFERRED EMBODIMENT

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations are not described in detail in order not to obscure the present invention.

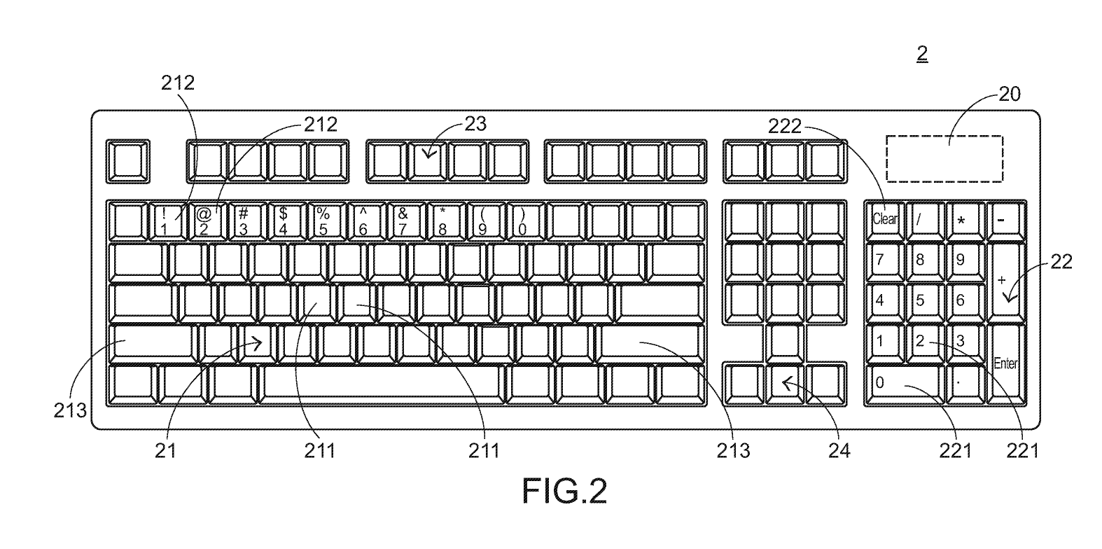

In view of the defects of the conventional arts, the present invention provides a keyboard device capable of making up the disadvantages of the conventional keyboard device. FIG. 2 illustrates an external structural schematic view of a keyboard device according to a preferred embodiment of the present invention. Referring to FIG. 2, the keyboard device 2 comprises a control unit 20, a first key region 21, a second key region 22, a third key region 23 and a fourth key region 24, wherein the first key region is defined as a standard key region, the second key region 22 is defined as a number key region, the third key region 23 is defined as a function key region, and the fourth key region 24 is defined as an expansion key region.

The first key region 21 comprises a plurality of letter keys 211, a plurality of first number keys 212 and at least one shift key 213. The plurality of letter keys 211 are arranged within the first key region 21 and exposed by a surface of the keyboard device 2, wherein each one of the plurality of letter keys 211 is capable of being pressed down by the user, so as to correspondingly generate a letter key code. The plurality of first number keys 212 are arranged within the first key region 21 and exposed by the surface of the keyboard device 2, wherein each one of the plurality of first number keys 212 is capable of being pressed down by the user, so as to correspondingly generate a first number key code. In the present preferred embodiment, each one of number key surfaces of the plurality of first number keys 212 is presented with a special symbol character and a number symbol character, wherein the number symbol characters thereof are “1” to “0” and the special symbol characters thereof “!” are “!” to “┘”. The shift key 213 is located at a first side of the first key region 21, and the first side of the first key region 21 can be a left side or a right side of the first key region 21. In the present preferred embodiment, the first side of the first key region 21 is the right side of the first key region 21.

The second key region 22 is arranged at the first side of the first key region 21 and comprises a plurality of second number keys 221 and a clear key 222. The plurality of second number keys 221 and the clear key 222 are arranged within the second key region 22 and exposed by the surface of the keyboard device 2, wherein each one of the plurality of second number keys 221 is capable of being pressed down, so as to correspondingly generate a second number key code, while the clear key 222 is capable of being pressed down, so as to generate a clear key code. In the present preferred embodiment, each one of number key surfaces of the plurality of second number keys 221 is only presented with a number symbol character, wherein the number symbol characters thereof are “1” to “0”. According to an external appearance of the keyboard device 2 of the present invention, it can be understood that the keyboard device 2 of the present invention is not disposed with a conventional number lock key therein, but disposed with a clear key 222 therein, and the characters presented on the number key surfaces are different from those presented on the number key surfaces of the conventional keyboard device 1 as well.

In the present preferred embodiment, each one of the key codes of each one of the above mentioned keys in the first key region 21, the second key region 22, the third key region 23 and the fourth key region 24 is a key code defaulted in a HID Usage Table, wherein the first number key codes are 1E, 1F, 20, 21, 22, 23, 24, 25, 26 and 27, and the second number key codes are 59, 5A, 5B, 5C, 5D, 5E, 5F, 60, 61 and 62. Since the keyboard device 2 of the present invention is not disposed with the conventional number lock key, the key code corresponding to the conventional number lock key in the HID Usage Table would not be used. With regard to the third key region 23 and the fourth key region 24, the functions and the arrangements thereof are all substantially typical to those of the conventional keyboard device 1 and thus omitted herein.

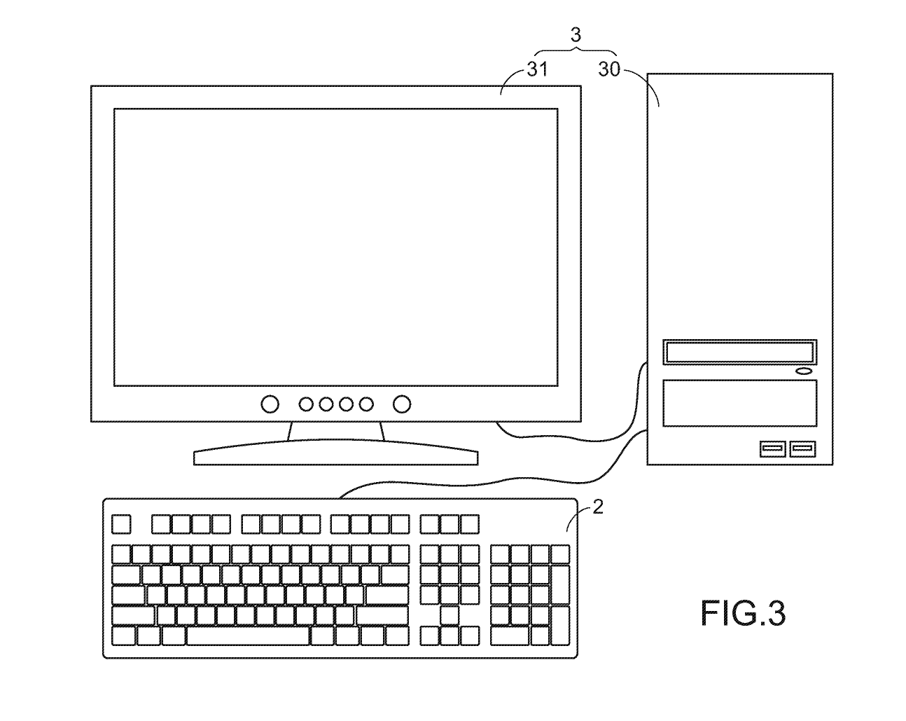

With regard to the control unit 20 arranged inside the keyboard device 2, which is electrically connected with all of the above mentioned keys in the first key region 21, the second key region 22, the third key region 23 and the fourth key region 24. In addition, the control unit 20 is capable of receiving and recognizing the key codes correspondingly generated by the above mentioned keys, so as to correspondingly output the signals. FIG. 3 illustrates an external structural schematic view of a keyboard device in communication with a computer system according to a preferred embodiment of the present invention. Referring to FIG. 2 and FIG. 3 together, the keyboard device 2 is in communication with a computer system 3, and the computer system 3 comprises a computer host 30 and a computer screen 31. Herein, the computer host 30 is in communication with the control unit 20 and capable of running at least one application program and receiving the signals from the control unit 20, so as to correspondingly execute the commands in the at least one application program. In addition, the computer screen 31 is in communication with the computer host 30 and capable of displaying the at least one application program.

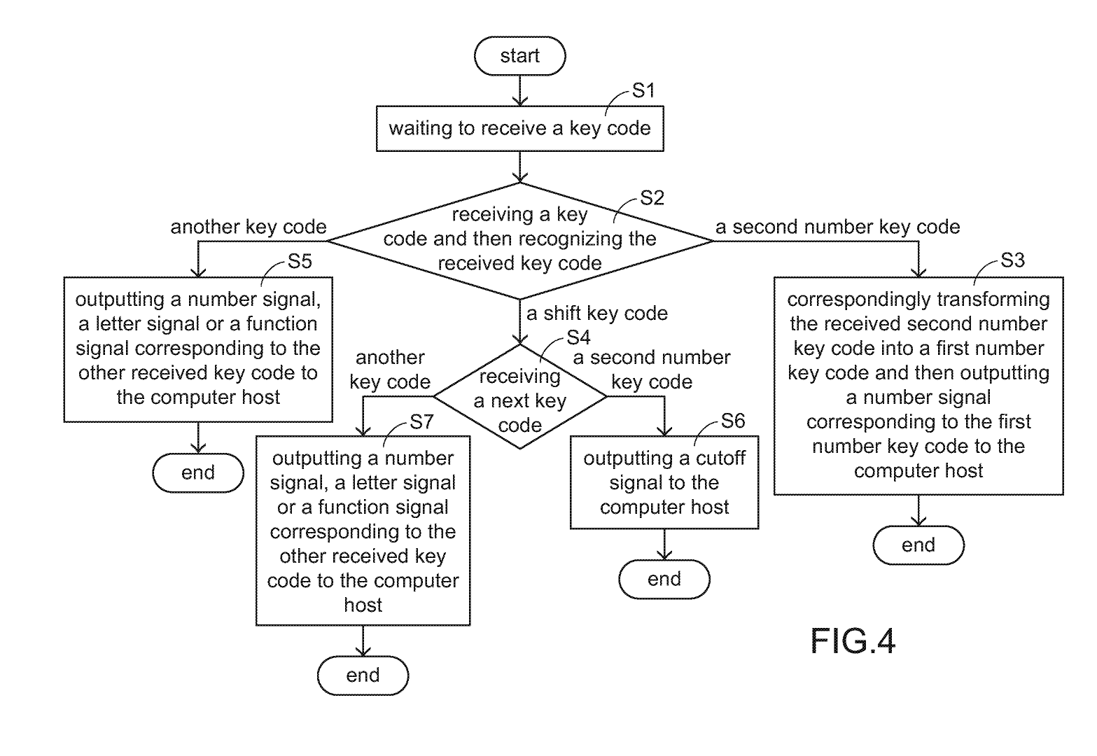

Next, an operation instance of the control unit 20 is illustrated hereinafter. FIG. 4 illustrates an operation block diagram of a control unit of a keyboard device according to a preferred embodiment of the present invention. Referring to FIG. 4, an operation process of the control unit 20 in the present preferred embodiment comprises the following steps. The step S1 is waiting to receive a key code. The step S2 is receiving a key code and then recognizing the received key code. The step S3 is correspondingly transforming a received second number key code into a first number key code and then outputting a number signal corresponding to the first number key code to the computer host 30. The step S4 is receiving a next key code. The step S5 is outputting a number signal, a letter signal or a function signal corresponding to the other received key code to the computer host 30. The step S6 is outputting a cutoff signal to the computer host 30. In addition, the step S7 is outputting a number signal, a letter signal or a function signal corresponding to the other received key code to the computer host 30. It should be noted that each one of the other received key codes in the step S5 and the step S7 can be any one of the key codes other than the second number key codes and the shift key code.

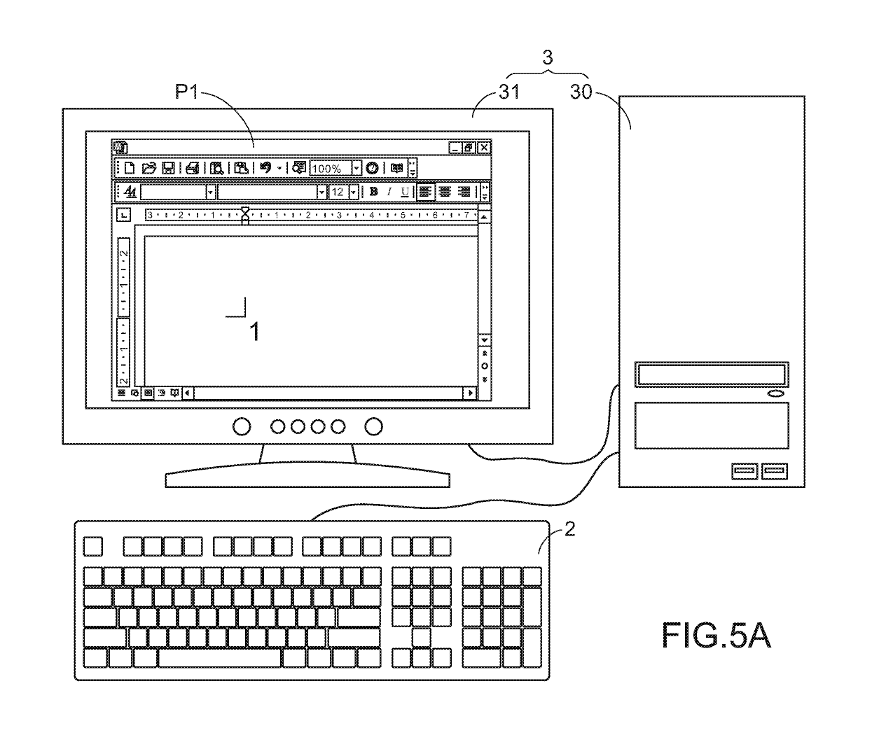

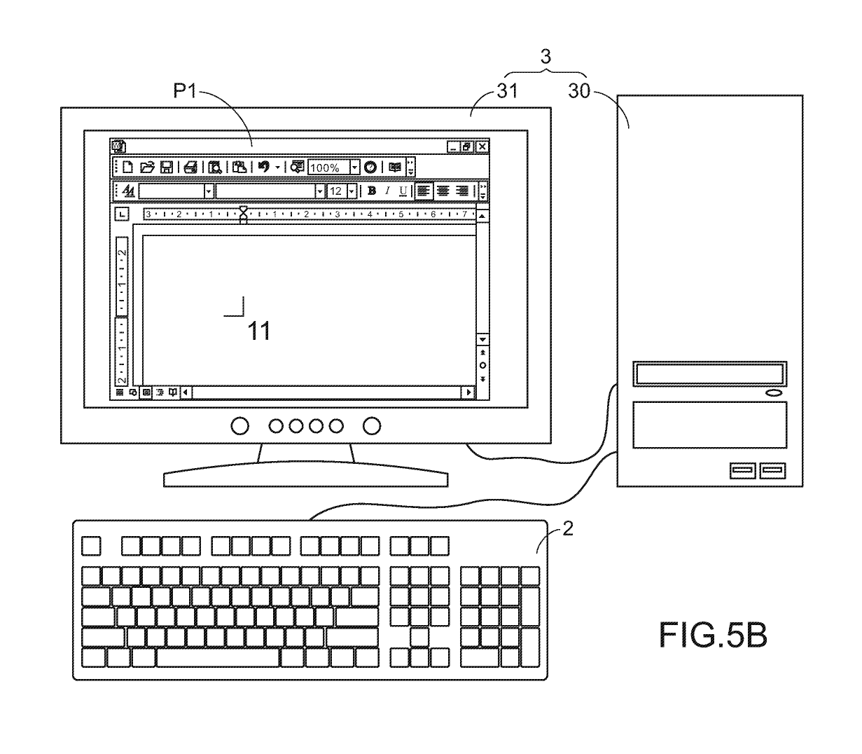

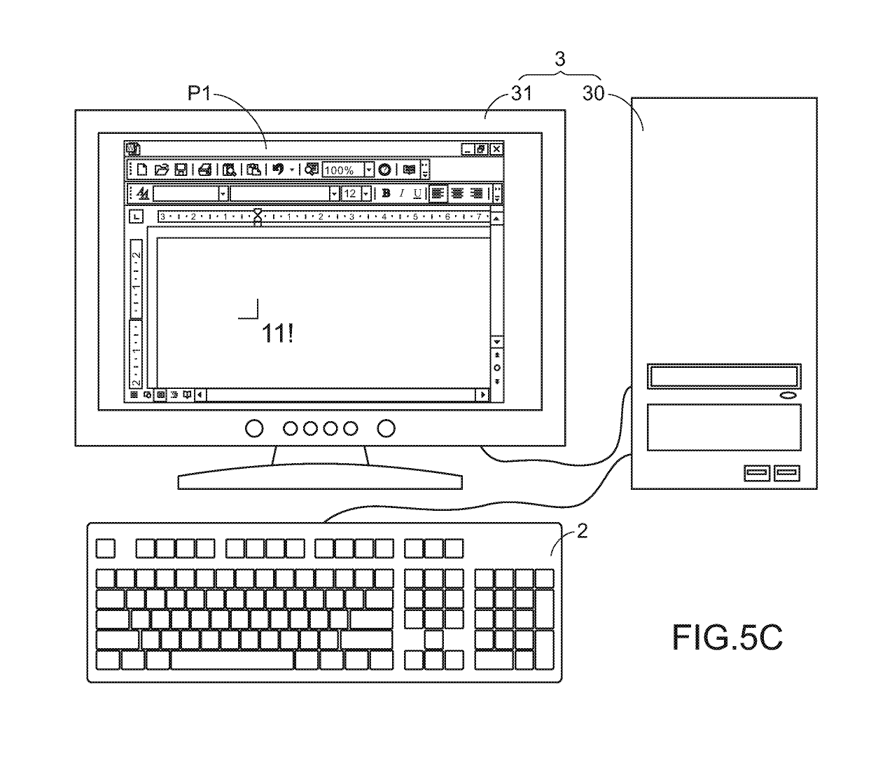

The following description illustrates an embodiment by using the first number key “1” in the first number keys 212. FIG. 5A to FIG. 5C illustrate a serial external structural schematic views about operating a keyboard device for controlling a computer system to run an application program according to a preferred embodiment of the present invention. Referring to FIG. 4 and FIG. 5A together first, the computer host 30 runs a first application program P1, and the first application program P1 is displayed in the computer screen 31. In the present preferred embodiment, the first application program P1 is a Microsoft Word program capable of running in a Windows OS. In the other hand, the control unit 20 inside the keyboard device 2 is waiting to receive a key code, i.e. the step S1. When the user presses down the first number key “1” in the first number keys 212 and then the first number key “1” correspondingly generates the first number key code (i.e. the first number key code 1E) to the control unit 20, the control unit 20 receives the first number key code (i.e. the first number key code 1E) and then recognizes the first number key code as a first number key code 1E, i.e. the step S2. After that, the control unit 20 outputs a number signal corresponding to the first number key code (i.e. the first number key code 1E) to the computer host 30, i.e. the step S5. In the end, the computer host 30 receives the number signal and a number “1” is keyed in to the application program P1, and then both of the application program P1 and the number “1” are displayed on the computer screen 31 as shown in FIG. 5A.

When the user presses down the clear key 222 of the second key region 22, the control unit 20 processes the step S1, the step S2 and the step S5 mentioned above as well and then outputs a clear signal corresponding to the clear code to the computer host 30, so as to let the computer host 30 execute a delete command when the computer host 30 runs the application program P1 and receives the clear signal, i.e. deleting a letter, a number or a symbol after a cursor.

The following description illustrates an embodiment by using the second number key “1” in the second number keys 221 in contrast with the above mention embodiment by using the first number key “1” in the first number keys 212. In the present embodiment, the first application program P1 is still running and displayed in the computer screen 31, and the control unit 20 is waiting to receive a key code as well, i.e. the step S1. When the user presses down the second number key “1” in the second number keys 221 and then the second number key “1” correspondingly generates the second number key code (i.e. the second number key code 59) to the control unit 20, the control unit 20 receives the second number key code (i.e. the second number key code 59) and then recognizes the second number key code as a second number key code 59, i.e. the step S2. After that, the control unit 20 correspondingly transforms the received second number key code (i.e. the second number key code 59) into a first number key code (i.e. the first number key code 1E) and then outputs a number signal corresponding to the first number key code (i.e. the first number key code 1E) to the computer host 30, i.e. the step S3. In the end, the computer host 30 receives the number signal and a number “1” is keyed in to the application program P1, and then both of the application program P1 and the number “1” are displayed on the computer screen 31 as shown in FIG. 5B.

The following description illustrates an embodiment by using the shift key 213 and the first number key “1” in the first number keys 212. Referring to FIG. 4 and FIG. 5C together, in the present embodiment, the first application program P1 is still running and displayed in the computer screen 31, and the control unit 20 is waiting to receive a key code also, i.e. the step S1. When the user continuously presses down the shift key 213, the shift key 213 correspondingly generates a shift key code, and the shift key code is then received by the control unit 20, i.e. the step S2. After that, when the user presses down the first number key “1” in the first number keys 212 accompanied with the shift key 213 continuously pressed down and then the first number key “1” correspondingly generates the first number key code (i.e. the first number key code 1E) to the control unit 20, the control unit 20 receives the first number key code (i.e. the first number key code 1E) and then recognizes the first number key code as a first number key code 1E, i.e. the step S4. After that, the control unit 20 outputs a special symbol signal (i.e. a special symbol signal “!”) corresponding to the first number key code (i.e. the first number key code 1E) to the computer host 30, i.e. the step S7. In the end, the computer host 30 receives the special symbol signal and a special symbol “!” is keyed in to the application program P1, and then the application program P1 and the special symbol “!” are both displayed on the computer screen 31 as shown in FIG. 5C.

The following description illustrates an embodiment by using the shift key 213 and the second number key “2” in the second number keys 221. In the present embodiment, the first application program P1 is still running and displayed in the computer screen 31, and the control unit 20 is waiting to receive a key code as well, i.e. the step S1. When the user continuously presses down the shift key 213, the shift key 213 generates a shift key code correspondingly, and the shift key code is then received by the control unit 20, i.e. the step S2. After that, when the user presses down the second number key “2” in the second number keys 221 accompanied with the shift key 213 continuously pressed down and then the second number key “2” correspondingly generates the second number key code (i.e. the second number key code 5A) to the control unit 20, the control unit 20 receives the second number key code (i.e. the second number key code 5A) and then recognizes the second number key code as a second number key code 5A, i.e. the step S4. After that, the control unit 20 outputs a cutoff signal to the computer host 30, i.e. the step S6. In the end, the computer host 30 receives the cutoff signal and stops to execute the commands, so that neither the special symbols nor the numbers is keyed in to the application program P1 as shown in FIG. 5C.

According to the above mentioned descriptions, it is understood that the keyboard device 2 of the present invention uses the control unit 20 to recognize which one of the keys is pressed down and then to output a corresponding key signal. Besides, when both of the shift key 213 and any one of the second number keys 221 are pressed down at the same time, the control unit 20 outputs a cutoff signal and thus the number corresponding to the second number key 221 being pressed down is not keyed in to the computer host 30. As a result, it is able to ensure that only a number can be keyed in to the computer host 30 rather than any one of the special symbols is keyed in or any one of the other function commands is executed when any one of the second number keys 221 is pressed down.

In the present preferred embodiment, the first application program P1 is the Microsoft Word program capable of running in the Windows OS. However, in the other preferred embodiments, the first application program P1 can further be a Microsoft Excel program capable of running in the Windows OS, a Microsoft Powerpoint program capable of running in the Windows OS, a Microsoft Word program capable of running in a Mac OS, a Microsoft Excel program capable of running in the Mac OS, a Microsoft Powerpoint program capable of running in the Mac OS, a Page program in the Mac OS, a Numbers program in the Mac OS or a Keynote program in the Mac OS. In a word, the keyboard device 2 of the present invention can not only be used in the Windows OS, but also use the functions thereof in the Mac OS.

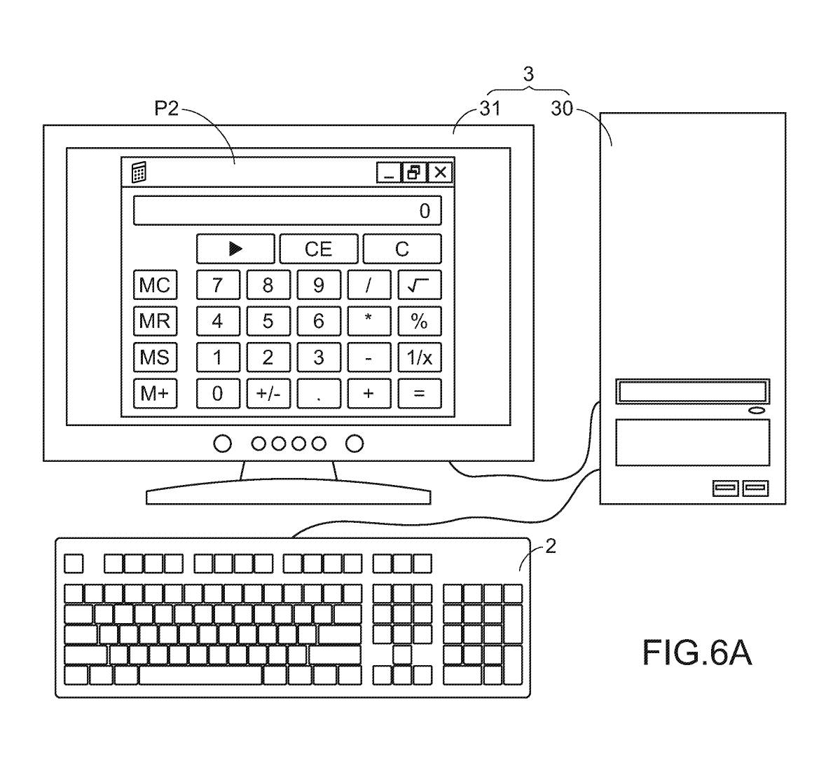

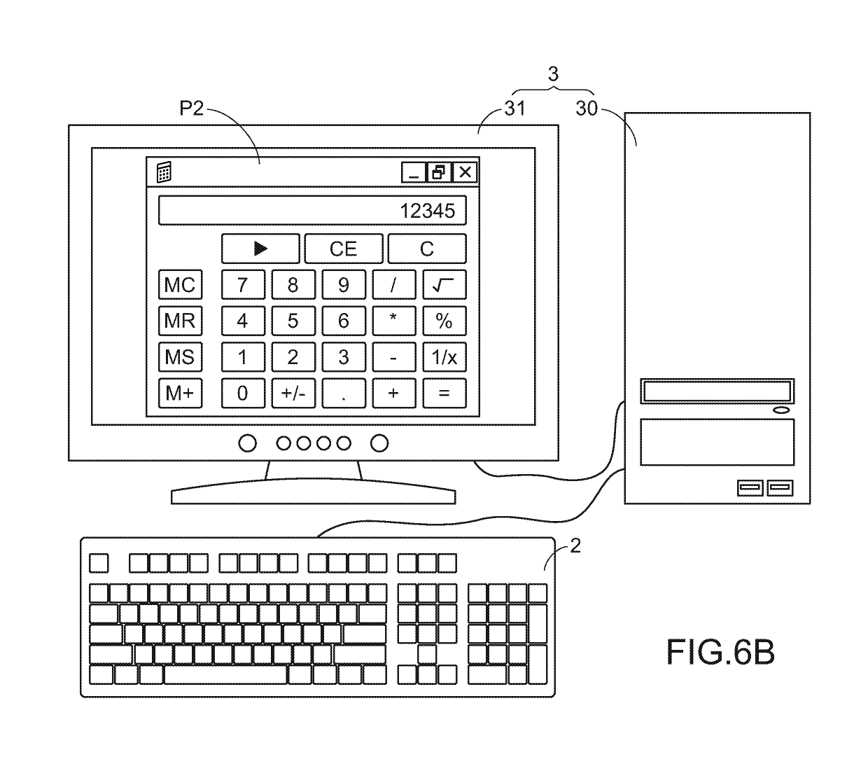

Next, an instance of using the computer host 30 to run another application program is illustrated hereinafter. Referring to FIG. 6A and FIG. 6B, which illustrate a serial external structural schematic views about operating a keyboard device for controlling a computer system to run another application program according to a preferred embodiment of the present invention. In FIG. 6A, the computer host 30 runs a second application program P2, and the second application program P2 is displayed in the computer screen 31. As the second application program P2 is in an initial state, a number 0 is presented in the second application program P2. In the present preferred embodiment, the second application program P2 is a calculator program capable of running in the Windows OS. The user can key in a string of numbers 12345 by processing the step S1, the step S2 and the step S5 mentioned above, and then the string of numbers 12345 can be keyed in to the second application program P2 of the computer host 30, and both of the second application program P2 and the string of numbers 12345 are then displayed in the computer screen 31 as shown in FIG. 6B.

When the user presses down the clear key 222 to generate the clear key code to the control host 30, the control unit 20 recognizes the clear key code and then outputs a clear signal to the computer host 30, so as to let the computer host 30 vary the string of numbers 12345 keyed in to the second application program P2 into the number 0 as shown in FIG. 6A. In another word, the function of the clear key 222 to the second application program P2 is switched to a function for clearing numbers. In the other preferred embodiments, the second application program can be a calculator program capable of running in the Mac OS as well.

According to the above mentioned descriptions, it is understood that the keyboard device of the present invention utilizes a feature of that the first number key and the second number key can key in the same number with different key codes. As a result, a second number key code is correspondingly transferred into a first number key code when the control unit receives a second number key code corresponding to a second number key, so as to key in a number. In addition, a cutoff signal is outputted when the control unit receives the shift key code and the second number key code together, so as to ensure that only a number can be keyed in when any one of the second number keys is pressed down due to the computer host not to execute the commands. As a result, it is unnecessary to switch the functions of the second number keys by using the number lock key when the user operates the keyboard device of the present invention, but the numbers can be keyed in by directly pressing down the second number keys instead, and thus it is convenient to be operated by the user. Certainly, in the keyboard device of the present invention, it is unnecessary to disposed with a number lock indicating lamp corresponding to the number lock key as well.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A keyboard device, in communication with a computer system, wherein the keyboard device comprises:
a first key region, comprising:
a plurality of first number keys, arranged within the first key region and exposed by a surface of the keyboard device, wherein each one of the plurality of first number keys is capable of being pressed down and thus correspondingly generates a first number key code; and
a shift key, arranged within the first key region and exposed by the surface of the keyboard device;
a second key region, located at a first side of the first key region, the second key region comprising a plurality of second number keys arranged within the second key region and exposed by the surface of the keyboard device, wherein each one of the plurality of second number keys is capable of being pressed down and thus correspondingly generates a second number key code; and
a control unit, arranged within the keyboard device and electrically connected with the plurality of first number keys, the plurality of second number keys and the shift key, wherein when the control unit receives a shift key code generated by the shift key and the first number key code generated by a corresponding one of the plurality of first number keys, the control unit outputs a special symbol signal corresponding to the first number key code; when the control unit receives the first number key code or the second number key code, the control unit outputs a number signal corresponding to the first number key code; and when the control unit receives the shift key code and the second number key code, the control unit outputs a cutoff signal.

2. The keyboard device as claimed in claim 1, wherein the computer system comprises:
a computer host, in communication with the control unit, capable of running at least one application program, and the at least one application program receiving the number signal or the special symbol signal and thus correspondingly executing a command; and
a computer screen, in communication with the computer host, capable of displaying the at least one application program and displaying a number corresponding to the number signal and a special symbol corresponding to the special symbol signal.

3. The keyboard device as claimed in claim 2, wherein when the computer host runs the at least one application program and receives the number signal, the computer host inputs the number corresponding to the number signal into the at least one application program, and the at least one application program and the number are displayed on the computer screen; when the computer host runs the at least one application program and receives the special symbol signal, the computer host inputs the special symbol corresponding to the special symbol signal into the at least one application program, and the at least one application program and the special symbol are displayed on the computer screen; and when the computer host runs the at least one application program and receives the cutoff signal, the computer host stops executing the command.

4. The keyboard device as claimed in claim 2, wherein the second key region further comprises a clear key arranged within the second key region, exposed by the surface of the keyboard device, and capable of being pressed down and thus generating a clear key code, such that the control unit outputs a clear signal to the computer host according to the clear key code.

5. The keyboard device as claimed in claim 4, wherein when the computer host runs the at least one application program and receives the clear signal, the computer host changes the number inputted into the at least one application program into 0.

6. The keyboard device as claimed in claim 5, wherein the at least one application program is a calculator program capable of running in a Windows operating system or a calculator program capable of running in a Mac operating system.

7. The keyboard device as claimed in claim 4, wherein when the computer host runs the at least one application program and receives the clear signal, the computer host executes a Delete command.

8. The keyboard device as claimed in claim 7, wherein the at least one application program is a Microsoft Word program capable of running in a Windows operating system, a Microsoft Excel program capable of running in the Windows operating system, a Microsoft Powerpoint program capable of running in the Windows operating system, a Microsoft Word program capable of running in a Mac operating system, a Microsoft Excel program capable of running in the Mac operating system, a Microsoft Powerpoint program capable of running in the Mac operating system, a Page program in the Mac operating system, a Numbers program in the Mac operating system or a Keynote program in the Mac operating system.

9. The keyboard device as claimed in claim 1, wherein the plurality of first number key codes generated by the plurality of first number keys are 1E, 1F, 20, 21, 22, 23, 24, 25, 26 and 27, and the plurality of second number key codes generated by the plurality of second number keys are 59, 5A, 5B, 5C, 5D, 5E, 5F, 60, 61 and 62.

10. The keyboard device as claimed in claim 1, wherein each one of number key surfaces of the plurality of first number keys is presented with a special symbol character and a number symbol character, but each one of number key surfaces of the plurality of second number keys is presented with the number symbol character only.
